(19) United States
(12) Patent Application Publication
(10) Pub. No.: US 2015/0039580 A1
(43) Pub. Date: Feb. 5, 2015

(54) APP ANNOTATION AND FACILITATON OF USER SEARCH TASK AND USER ACTION

(71) Applicant: Microsoft Corporation, Redmond, WA (US)

(72) Inventor: Sameeksha Suresh Subhedar, Redmond, WA (US)

(73) Assignee: Microsoft Corporation, Redmond, WA (US)

(21) Appl. No.: 13/956,142

(22) Filed: Jul. 31, 2013

(51) Int. Cl. G06F 17/30

(52) U.S. Cl. CPC G06F 17/30864
USPC 707/706; 707/769

(57) ABSTRACT

One or more techniques and/or systems are provided for annotating apps and/or for facilitating performance of a user search task. That is, app metadata associated with an app, exposed through an app store, may be evaluated to determine various identifying information for the app (e.g., an app subcategory, an action that may be performed by the app, a user segment/demographic that may find the app interesting or relevant, etc.). The app may be annotated with one or more annotations based upon the identifying information. When a search user submits a search query, a search intent (e.g., reserve a table for 2 at The Restaurant) may be determined and used to identify an app that may satisfy the search intent based upon the app comprising one or more annotations matching the search intent. In this way, the search user may efficiently perform a user search task/action using an appropriate app.

### BACKGROUND

Many services and/or computing devices expose apps for selective deployment on client devices. For example, an operating system, a video game console, a search engine, or a variety of other services and/or devices may host app stores through which users may obtain apps. In an example, a user of a tablet device may navigate to an app store accessible through the tablet device. The user may search, through trial and error, for an app that may allow the user to create and share birthday party invitations with other users. Once the user locates an invitation app, the user may download, deploy, and initialize the invitation app on the tablet device. After initialization, the user may interactively navigate the invitation app to a birthday party invitation user interface through which the user may create and share birthday party invitations.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for annotating an app and/or for facilitating performance of a user search task are provided herein. In an example of annotating an app, an app exposed through an app store may be identified, such as an invitation app. App metadata may be associated with the invitation app. The app metadata may comprise an app description for the invitation app specified by the app store (e.g., “the invitation app allows users to create and share invitations with other users . . . ”), a user review for the invitation app (e.g., “I was able to make a great birthday party invite . . . ”), an app developer description for the app or an update to the app (e.g., “we recently added the ability to make birthday invites through our app . . . ”), an app catalogue category for the app specified by the app store (e.g., a social category), and/or a variety of other information about the invitation app. The app metadata may be evaluated to identify an app subcategory (e.g., a party invitation category), an action (e.g., a create birthday invitation action), a location context (e.g., the app may be associated with a particular party center located in Miami), a user segment context (e.g., the app may be targeted to birthday party planners and sports party planners), an event context (e.g., the app may provide sports party invitation functionality for an upcoming Olympics), etc. In this way, the invitation app may be annotated with an app subcategory annotation, an action annotation, a location context annotation, a user segment context annotation, an event context annotation, and/or other annotations comprising information about the app that may be used to identify the app as corresponding to a search intent of a search user (e.g., the invitation app may be identified and/or provided to a search user based upon one or more annotations of the invitation app matching a search intent derived from a search query “I need to create invitations for a birthday party . . . ”).

In an example of facilitating performance of a user search task, a search query submitted by a search user may be identified (e.g., a search query “I need to create invitations for a birthday party . . . ” submitted through an app search engine). A search intent of the search user may be determined based upon a query context derived from the search query (e.g., various heuristics, such as word matching techniques, grammar evaluation, web search engine categorization, entity extraction, and/or other techniques may be used to evaluate the search query to derive the query context) and/or a user context derived from the search user (e.g., a social network profile, a current user location, a user browser session corresponding to search queries and/or websites visited by the search user, a user segment such as age, gender, employment status, hobbies, etc., and/or other information about the search user). For example, the search intent may specify that the search user is an adult with a one year old child, and that the search user is planning a 1 year birthday party in Miami for the one year old child, and thus the search user is searching for an app that may allow the search user to create birthday invites for the birthday party (e.g., the search intent corresponds to an entity category “birthday party”, an action “create invites”, an action parameter “one year old party” and “Miami”, an action qualifier “create birthday invites”, etc.). The search intent may be used to query an index of annotations of apps to identify an app having on or more annotations that match the search intent. For example, the search intent may match one or more annotations for the invitation app. The invitation app may be provided to the search user in a contextually relevant state based upon a set of task parameters derived from the search intent. For example, the invitation app may be deployed to a client device of the search user, and may be initialized to a birthday party invitation user interface comprising a template for a one year old birthday party and/or party center information for Miami. In this way, the invitation app may be identified, deployed, and provided to the search user in a contextually relevant state based upon the search query.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1A is a flow diagram illustrating an exemplary method of annotating an app.

FIG. 1B is an example of evaluating app metadata.

FIG. 2 is a component block diagram illustrating an exemplary system for annotating an app.

FIG. 3 is a component block diagram illustrating an exemplary system for annotating an app.

FIG. 4 is a flow diagram illustrating an exemplary method of facilitating performance of a user search task.

FIG. 5 is a component block diagram illustrating an exemplary system for facilitating performance of a user search task.

FIG. 6 is a component block diagram illustrating an exemplary system for facilitating performance of a user search task.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

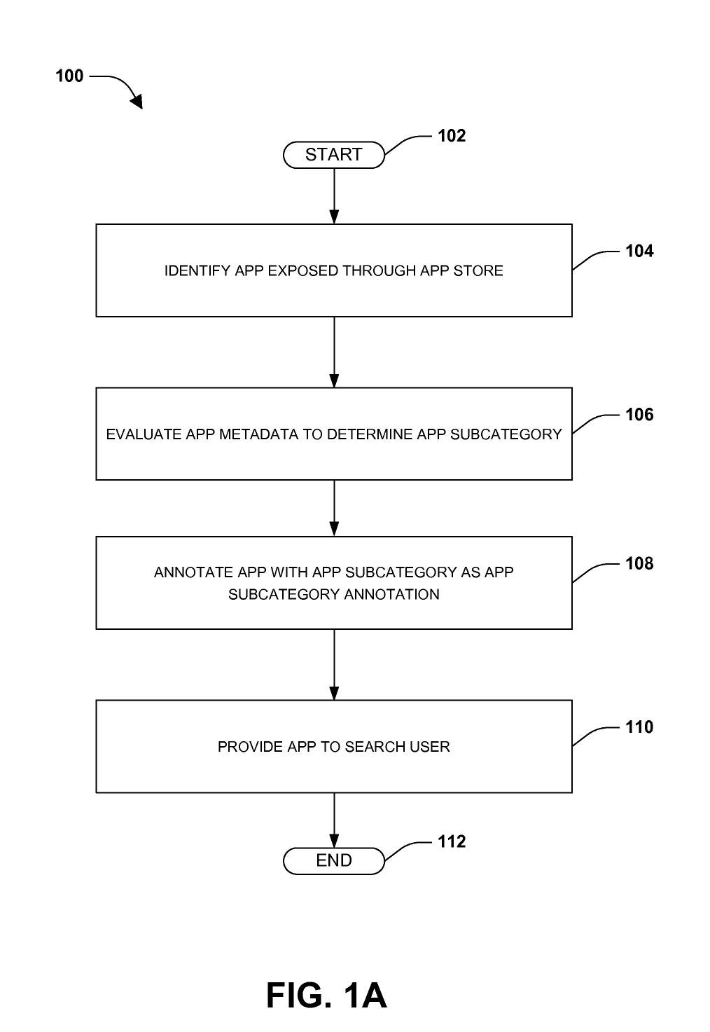

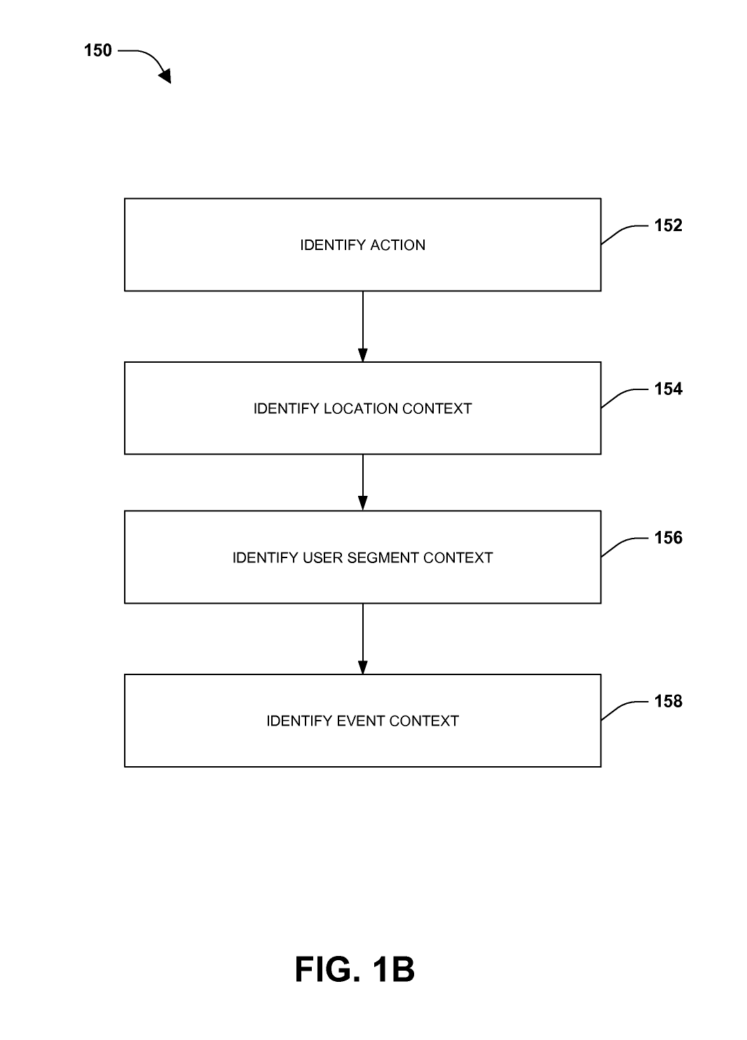

An embodiment of annotating an app is illustrated by an exemplary method 100 of FIG. 1A. At 102, the method starts. A service or computing device, such as an operating system, a search engine, a video game console, a mobile device, etc., may host an app store through which users may obtain apps. As provided herein, such apps may be annotated with additional information that may be used to identify an app that may be provided to a search user in order to facilitate performance of a user search task using the app (e.g., identify and provide a Cleveland sports team app to a search user so that the search user may order tickets for a Cleveland sports game). Accordingly, an app, exposed through an app store, may be identified, at 104. In an example, the app may be identified generally, simply by being exposed through the app store, as opposed to being identified based upon certain criteria that the app meets. Accordingly, the instant application, including the scope of the appended claims, is not to be unduly limited by the identification, selection, etc. of an app for annotation. App metadata may be associated with the app. The app metadata may comprise an app description for the app specified by the app store (e.g., “the Cleveland sports team app allows users to track their favorite Cleveland baseball team . . . ”), a user review for the app (e.g., “the Cleveland sports team app allowed me to book game day tickets . . . ”), an app developer description for the app (e.g., “our app allows users to buy tickets, view live gameplay clips, . . . ”), an app catalog category of the app specified by the app store (e.g., a Sports category), and/or other information.

The app metadata may be evaluated to determine a facet, such as an app subcategory (e.g., the Sports category may be further refined to a baseball category), an action, a location context, a user segment context, an event context, and/or other contextual information, at 106. It may be appreciated that an example of evaluating the app metadata is illustrated in example 150 of FIG. 1B. For example, the app metadata may be evaluated to determine a facet about the app, such as an action that may be performed by the app (e.g., an order tickets action, a view video action, etc.) at 152, a location context of the app (e.g., a Cleveland sports team app may be associated with Cleveland Ohio) at 154, a user segment context (e.g., the Cleveland sports team app may be targeted at sports fans in Ohio) at 156, an event context (e.g., the Cleveland sports team app may be associated with an upcoming baseball season) at 158, etc.

At 108, the app may be annotated with an app subcategory annotation and/or other annotations (e.g., as identified per FIG. 1B) that may be useful for identifying the app as matching a search intent of a search user based upon the app being capable for performing a user search task of the search user (e.g., booking tickets to tonight's baseball game). In an example, the Cleveland sports team app may be annotated with a baseball subcategory. In another example, the Cleveland sports team app may be annotated with an action annotation for purchasing tickets or viewing gameplay clips. In another example, the Cleveland sports team app may be annotated with a location context annotation for Cleveland. In another example, the Cleveland sports team app may be annotated with a user segment context annotation for Ohio baseball fans. In another example, the Cleveland sports team app may be annotated with an event context annotation for an upcoming baseball season. It may be appreciated that an app may be annotated with multiple facets of contextual information (e.g., the Cleveland sports team app may be annotated with the event context annotation, the user segment context annotation, the location context annotation, and/or other annotations). In this way, various information may be used to annotate the app for later identification, retrieval, and/or deployment to a client device for facilitating performance of a user search task.

At 110, responsive to determining that a search intent of a search query submitted by a search user corresponds to one or more annotations of the app, the app may be provided to the search user (e.g., the app may be downloaded, deployed, and initialized in a contextually relevant state with respect to the search intent). For example, a search user may submit a query “I want to book 2 tickets for tonight's game”. A search intent for purchasing 2 baseball tickets for a Cleveland baseball game at 6:00 today may be determined. The search intent may be used to evaluate annotated apps exposed through the app store (e.g., apps may be indexed within an app index based upon annotations associated with such apps, and thus the app index may be queried with the search intent to identify an app associated with annotations correspond to the search intent). Based upon the search intent corresponding to one or more annotations of the Cleveland sports team app, the Cleveland sports team app may be provided to the search user in a contextually relevant state. For example, the Cleveland sports team app may be initialized into an order tickets user interface through which the user may efficiently order 2 tickets for the Cleveland baseball game (e.g., the order tickets user interface may be prepopulated with the particular game, number of tickets, date, and/or other information). At 112, the method ends.

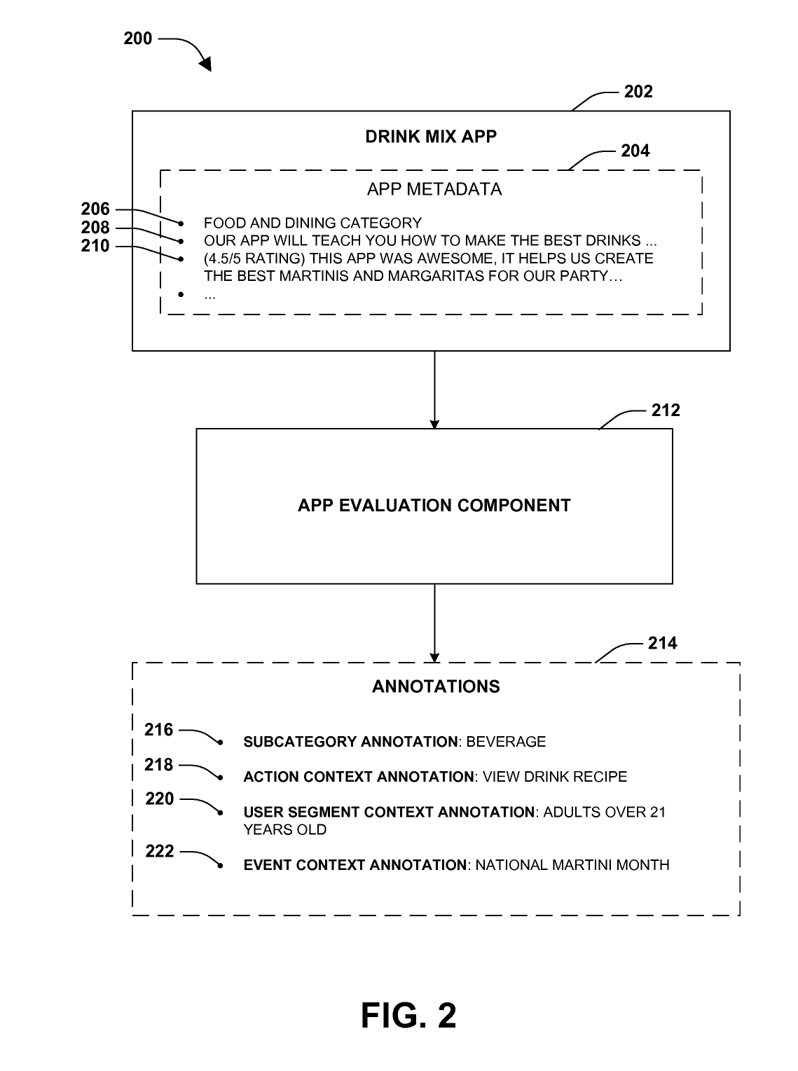

FIG. 2 illustrates an example of a system 200 for annotating an app. The system 200 may comprise an app evaluation component 212 associated with an app store. The app evaluation component 212 may identify a drink mix app 202 (e.g., and/or other apps) exposed through the app store for download and/or deployment to client devices. The app evaluation component 212 may evaluate app metadata 204 associated with the drink mix app 202. For example, the app metadata 204 may specify a Food and Dining category 206 for the drink mix app 202, an app developer description 208 (e.g., “our app will teach you how to make the best drinks . . . ”), a user review 210 (e.g., “4.4/5 rating—this app was awesome, it helps us create the best martinis and margaritas for our party . . . ”), and/or other information for the drink mix app 202.

The app evaluation component 212 may determine a subcategory of beverage based upon the app developer description (e.g., various heuristics may be used to determine that words, corresponding to beverage, may frequently appear within the app metadata 204, such as the app developer description 208). The app evaluation component 212 may determine an action context of a view drink recipe action based upon the app developer description 208 and/or the user review 210. The app evaluation component 212 may determine a user segment context of adults over 21 based upon the app metadata 204 indicating that the drink mix app 202 pertains to alcoholic beverages. The app evaluation component 212 may determine an event context of national martini month based upon an upcoming local or global event (e.g., identifiable from an informational source, such as a national bartender website). In this way, the app evaluation component 212 may annotate the drink mix app 202 with annotations 214, such as a subcategory annotation 216, an action context annotation 218, a user segment context annotation 220, and/or an event context annotation 222.

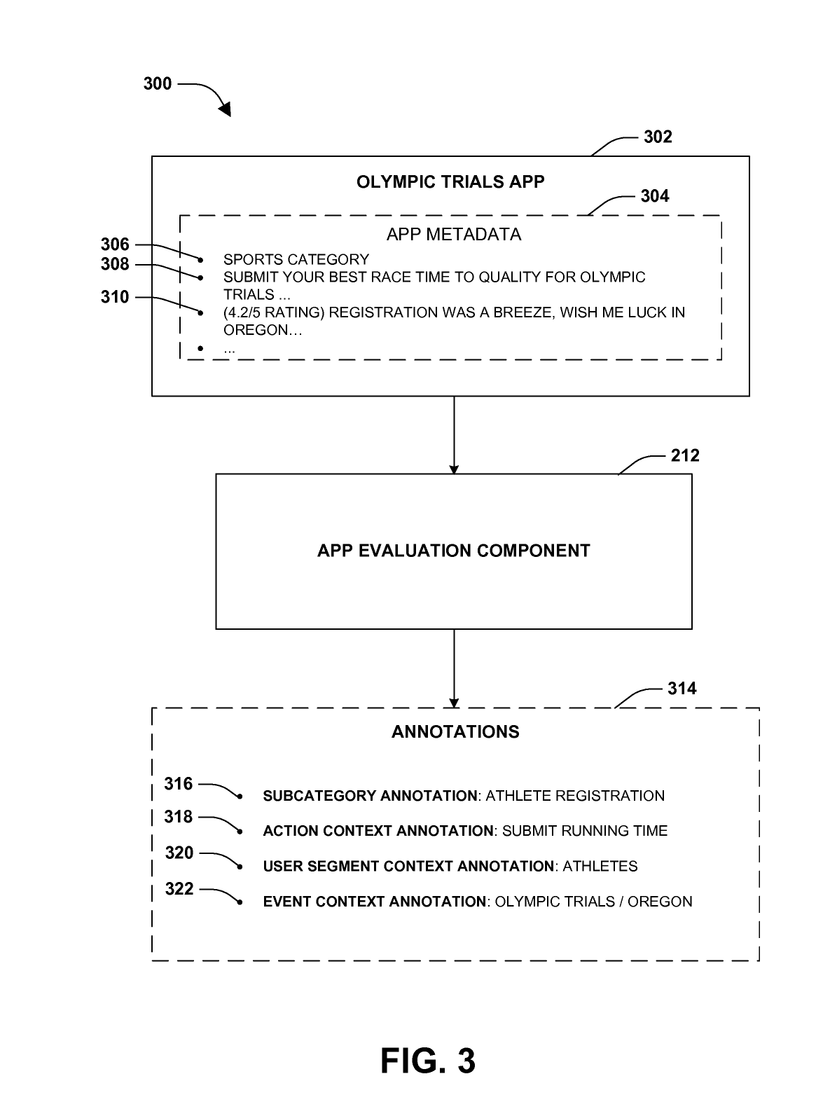

FIG. 3 illustrates an example of a system 300 for annotating an app. The system 300 may comprise an app evaluation component 212 associated with an app store. The app evaluation component 212 may identify an Olympic Trials app 302 (e.g., and/or other apps) exposed through the app store for download and/or deployment to client devices. The app evaluation component 212 may evaluate app metadata 304 associated with the Olympic Trials app 302. For example, the app metadata 304 may specify a sports category 306 for the Olympic Trials app 302, an app developer description 308 (e.g., “submit your best race time to quality for Olympic Trials . . . ”), a user review 310 (e.g., “4.2/5 rating—registration was a breeze, wish me luck in Oregon . . . ”), and/or other information for the Olympic Trials app 302.

The app evaluation component 212 may determine a subcategory of athlete registration based upon the user review 310 (e.g., various heuristics may be used to determine that words, corresponding to athlete registration, may frequently appear within the app metadata 204, such as the user review 310). The app evaluation component 212 may determine an action context of a submit running time action based upon the app developer description 308. The app evaluation component 212 may determine a user segment context of athletes based upon the app metadata 204 indicating that the Olympic Trials app 302 pertains to the Olympic Trials and registration. The app evaluation component 212 may determine an event context of Olympic Trials and Oregon where the Olympic Trials are held based upon an upcoming global event of the Olympic Trials (e.g., identifiable from an informational source, such as an Olympic Trials website). In this way, the app evaluation component 212 may annotate the Olympic Trials app 302 with annotations 314, such as a subcategory annotation 316, an action context annotation 318, a user segment context annotation 320, and/or an event context annotation 322.

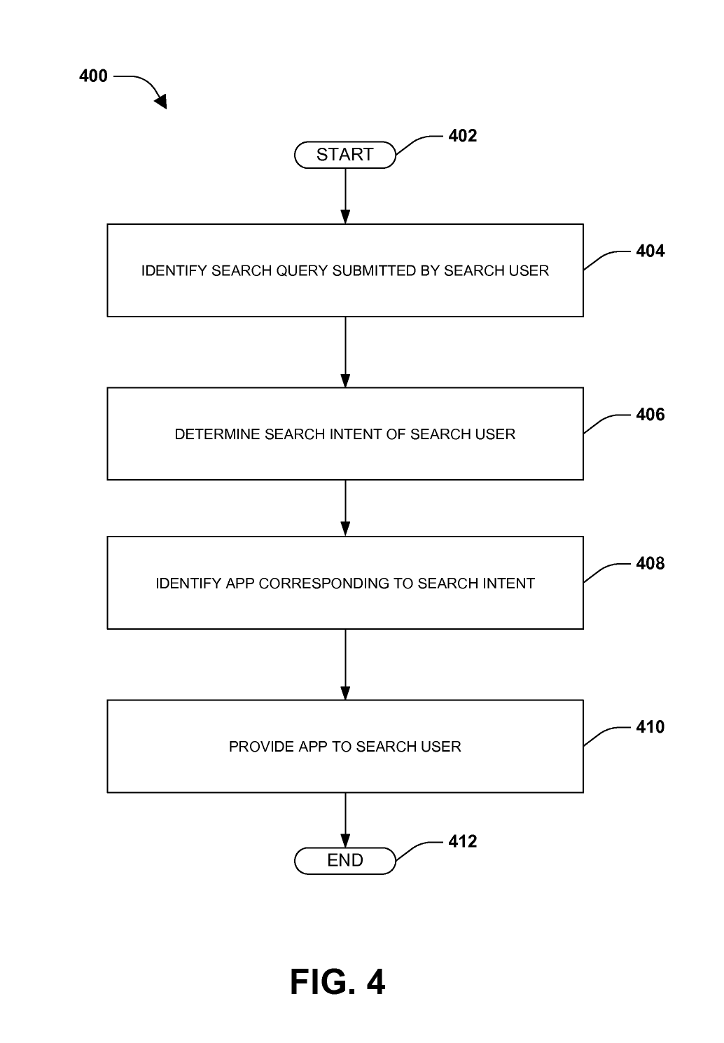

An embodiment of facilitating performance of a user search task is illustrated by an exemplary method 400 of FIG. 4. At 402, the method starts. At 404, a search query submitted by a search user may be identified. For example, the search user may submit, using a client device such as a tablet device, a search query “how to register for Olympic Trials” through a search interface associated with an app store that may expose apps for download and/or deployment on client devices. At 406, a search intent of the search user may be determined based upon a query context derived from the search query and/or a user context derived from the search user. In an example of deriving the query context, the search query may be utilized to assign classifier scores to one or more potential entity categories. A classifier score may indicate an amount of correlation between the search query and a potential entity category (e.g., a relatively higher score may be assigned to an Olympic category as opposed to a home renovation category). In another example, a grammar evaluation of the search query may be performed to identify the search intent (e.g., heuristics, such as word count, may be used to determine the search intent). In another example, a web search engine may be invoked to evaluate the search query to identify the search intent (e.g., the search engine may determine that Olympic Trials in Oregon is occurring soon). In another example, an entity extractor may be invoked to identify one or more entities as the search intent (e.g., an Olympic Trials entity may be identified from the search query).

In an example, the user context may correspond to a user location (e.g., a current location of the search user), a user segment (e.g., a user search profile, such as a social network profile, may indicate that the search user is an athlete), a user session (e.g., a web browser session may indicate that the search user was recently searching for and/or interacting with web content associated with Olympics or sports). In another example, the search intent may correspond to a global context associated with the search query. For example, the global context may correspond to a current time, a current event (e.g., the Olympic Trials), a local event (e.g., an Olympic Trials registration location that is relatively close to the current location of the search user), etc. In this way, the search intent (e.g. register for Olympic Trials) may be determined. For example, the search intent may correspond to an entity category (e.g., “sports”, “Olympics”, “Olympic Trials”, etc.), an action (e.g., a register for Olympic Trials action, etc.), an entity (e.g., “Olympic Trials”, etc.), an entity qualifier (e.g., Olympic Trials in Oregon, etc.), an action parameter (e.g., a registration name, a particular event to register for, a qualifying race result time, etc.), an action qualifier (e.g., “electronic registration”), etc.

At 408, an app corresponding to the search intent may be identified based upon the app corresponding to an entity category specified by the search intent and/or based upon the app comprising functionality capable of performing an action specified by the search intent. For example, app metadata associated with an Olympic Trials app (e.g., 302 of FIG. 3), such as one or more annotations (e.g., an action context annotation, an app subcategory annotation, a location context annotation, a user segment context annotation, an event context annotation, etc.) may indicate that the Olympic Trials app may be associated with an athlete registration subcategory and/or is capable of performing a submit running time action for Olympic Trials registration.

At 410, the app may be provided to the search user in a contextually relevant state based upon a set of task parameters derived from the search intent. The set of task parameters may comprise the entity, the action, the entity qualifier, and/or one or more action qualifiers and/or action parameters (e.g., a temporal parameter, a locational parameter, a quantity parameter, a payment parameter, or any other parameter that may be used by the Olympic Trials app (e.g., 302 of FIG. 3) to perform the action). For example, the Olympic Trials app may be downloaded, deployed, and/or initialized to an athlete registration user interface comprising prepopulated information from the set of task parameters (e.g., registration for Olympic Trials in Oregon for running). Because the Olympic Trials app is initialized to the athlete registration user interface, the search user may efficiently perform the user search task of registering for the Olympic Trials with minimal to no additional user input beyond submitting the search query. In an example, a task completion setting may indicate that automatic performance of the action may be performed without soliciting user input from the search user (e.g., the Olympic Trials app 302 may be instructed to register the search user automatically based upon identification of the search query). At 412, the method ends.

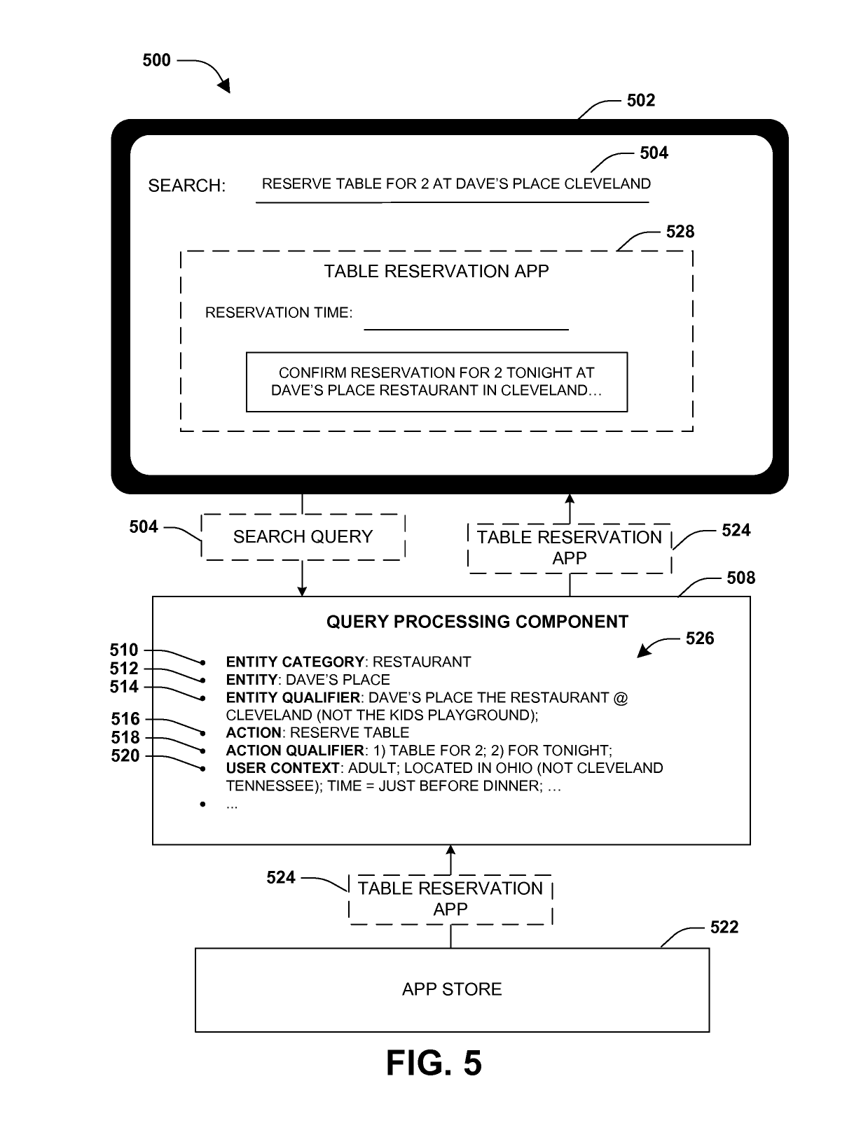

FIG. 5 illustrates an example of a system 500 configured for facilitating performance of a user search task. The system 500 may comprise a query processing component 508 associated with an app store 522 through which a client device, such as client device 502, may obtain apps. The query processing component 508 may be configured to identify a search query 504 (e.g., “reserve table for 2 at Dave's Place Cleveland”) submitted by a search user. The query processing component 508 may be configured to determine a search intent 526 of the search user based upon a query context derived from the search query 504 and/or a user context 520 derived from the search user. For example, an entity category 510 (e.g., a restaurant category), an entity 512 (e.g., Dave's Place), an entity qualifier 514 (e.g., Dave's Place the restaurant in Cleveland, as opposed to Dave's Place the kids playground near Cleveland), an action 516 (e.g., a reserve table action), and/or an action qualifier 518 (e.g., reserve table for 2 and table reservation for tonight) may be identified as the search intent 526 based upon various heuristics (e.g., word counts), classifier techniques (e.g., category classification), grammar evaluation, web search engine results or classifications, and/or entity extraction techniques (e.g., identification of a proper noun such as a location, business, person, product, etc.).

The user context 520 may be derived from a search user profile (e.g., a social network profile and/or other information indicating that the search user is an adult without children, lives in Ohio, and the current time is just before 5:00 pm). The user context 520 may indicate that the search intent 526 of the search user may correspond to Dave's place the restaurant, as opposed to the playground, based upon the search user being an adult without children. The user context 520 may indicate that the search intent 526 of the search user may correspond to Dave's Place in Cleveland, Ohio as opposed to Dave's place in Cleveland, Tenn. based upon the current location of the search user being located in Ohio.

The query processing component 508 may identify a table reservation app 524, available from the app store 522, as corresponding to the search intent 526 of the search user (e.g., one or more annotations of the table reservation app 524 may correspond to the search intent 526). Accordingly, the query processing component 508 may provide the table reservation app 524 to the search user in a contextually relevant state 528 based upon a set of task parameters derived from the search intent 526 (e.g., a reservation action parameter, a number of seats parameter of 2, an entity parameter of Dave's Place, a location parameter of Cleveland Ohio, an action qualifier of reserve booth, etc.). In this way, the search user may efficiently perform the user search task of reserving a table by merely providing a reservation time through the table reservation app 524 in the contextually relevant state 528.

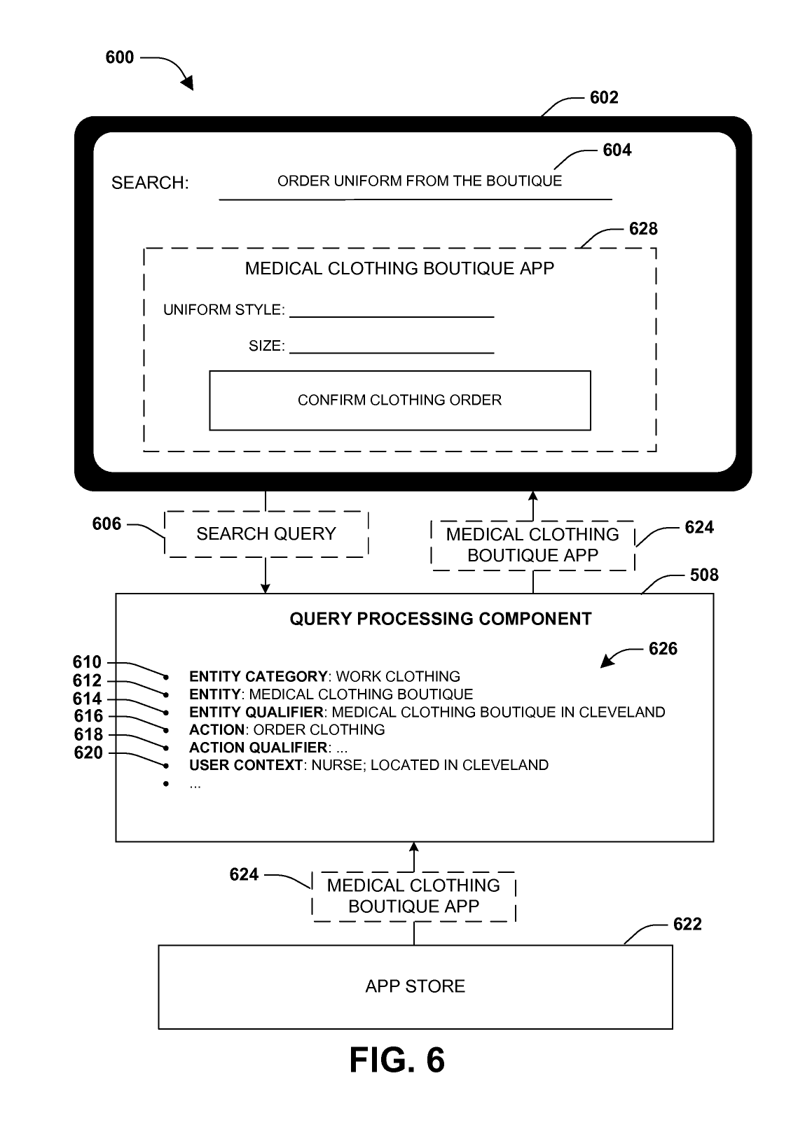

FIG. 6 illustrates an example of a system 600 configured for facilitating performance of a user search task. The system 600 may comprise a query processing component 508 associated with an app store 622 through which a client device, such as client device 602, may obtain apps. The query processing component 508 may be configured to identify a search query 604 (e.g., “order uniform from boutique”) submitted by a search user. The query processing component 508 may be configured to determine a search intent 626 of the search user based upon a query context derived from the search query 604 and/or a user context 620 derived from the search user. For example, an entity category 610 (e.g., a work clothing category derived from the term “uniform” and from personalization information about the search user being a nurse seeking medical uniforms as opposed to a person seeking other types of uniforms such as school uniforms), an entity 612 (e.g., Medical Clothing Boutique derived from the term “boutique”, “uniform”, and from the personalization information about the search user being a nurse), an entity qualifier 614 (e.g., the Medical Clothing Boutique in Cleveland derived from a current location of the search user), an action 616 (e.g., order clothing), and/or an action qualifier 618 may be identified as the search intent 626 based upon various heuristics (e.g., word counts), classifier techniques (e.g., category classification), grammar evaluation, web search engine results or classifications, and/or entity extraction techniques (e.g., identification of a proper noun such as a location, business, person, product, etc.).

The user context 620 may be derived from a search user profile (e.g., a social network profile and/or other information indicating that the search user is a nurse, lives in Ohio, etc.). The user context 620 may indicate that the search intent 626 of the search user may correspond to a medical clothing uniform as opposed to a school uniform or other type of uniform, and that the boutique corresponds to medical clothing as opposed to a boutique selling a different type of clothing. The user context 620 may indicate that the search intent 626 of the search user may correspond to the Medical Clothing Boutique in Cleveland as opposed to a different type of clothing boutique and/or a boutique in a different location.

The query processing component 508 may identify a Medical Clothing Boutique app 624, available from the app store 622, as corresponding to the search intent 626 of the search user (e.g., one or more annotations of the Medical Clothing Boutique app 624 may correspond to the search intent 626). Accordingly, the query processing component 508 may provide the Medical Clothing Boutique app 624 to the search user in a contextually relevant state 628 based upon a set of task parameters derived from the search intent 626 (e.g., an order clothing action parameter, a medical clothing parameter, a nurse clothing parameter, an e-commerce action qualifier, etc.). In an example, the search user may select a uniform style, size, quantity, etc. in order to complete a clothing order. In this way, the search user may efficiently perform the user search task of ordering nursing uniforms through the Medical Clothing Boutique app 624 in the contextually relevant state 628.

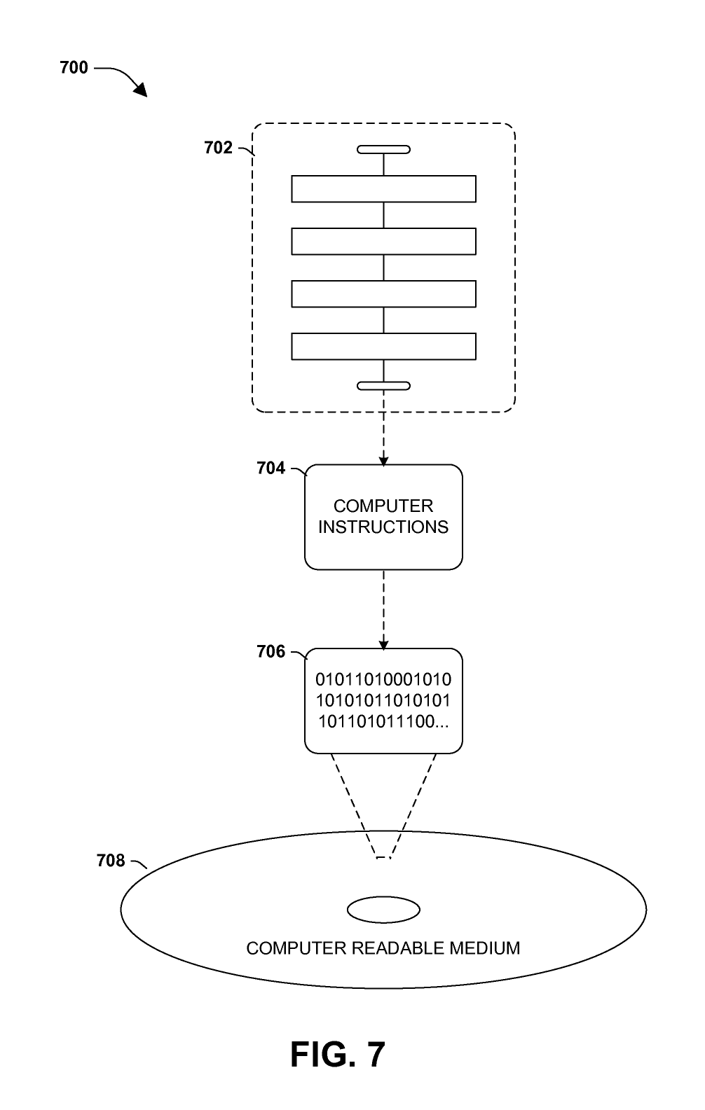

Still another embodiment involves a computer-readable medium comprising processor-executable instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1A and/or at least some of the exemplary method 400 of FIG. 4, for example. In some embodiments, the processor-executable instructions 704 are configured to implement a system, such as at least some of the exemplary system 200 of FIG. 2, at least some of the exemplary system 300 of FIG. 3, at least some of the exemplary system 500 of FIG. 5, and/or at least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

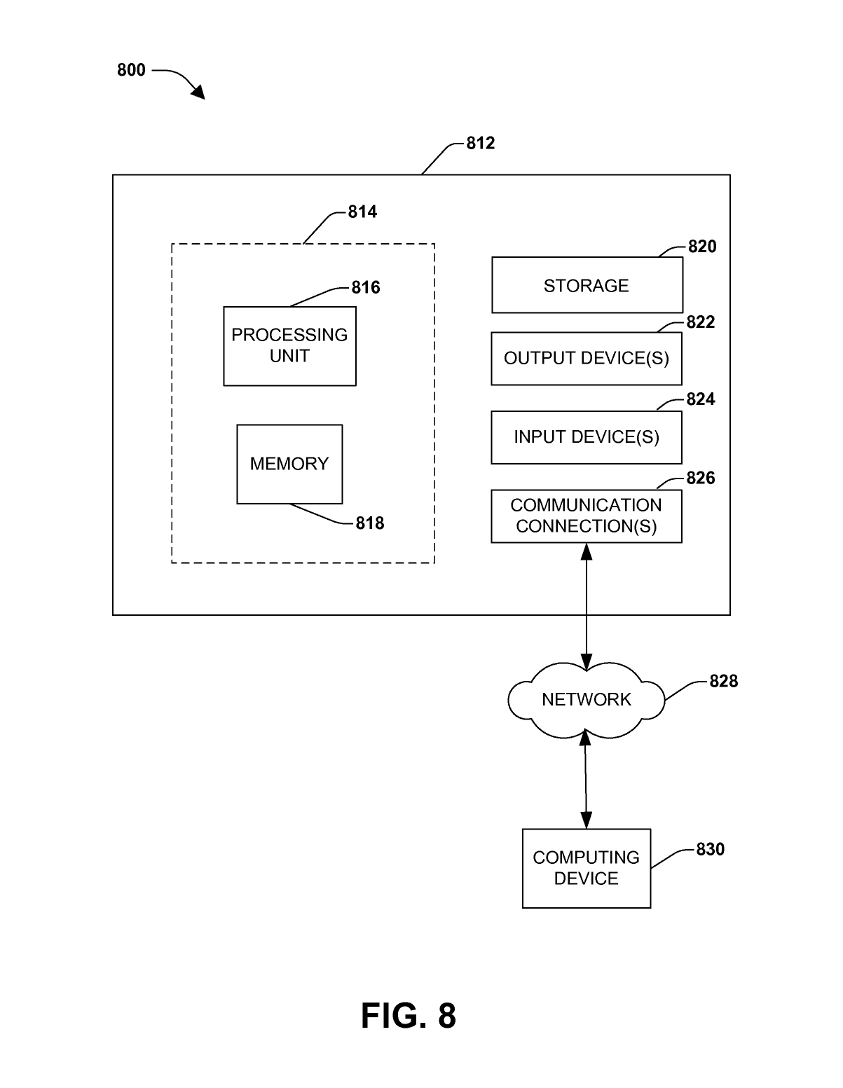

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for facilitating performance of a user search task, comprising:
identifying a search query submitted by a search user;
determining a search intent of the search user based upon at least one of a query context derived from the search query or a user context derived from the search user;
identifying an app corresponding to the search intent based upon at least one of the app corresponding to an entity category specified by the search intent or the app comprising functionality capable of performing an action specified by the search intent; and
providing the app to the search user in a contextually relevant state based upon a set of task parameters derived from the search intent.

2. The method of claim 1, the search intent corresponding to least one of the entity category, the action, an entity, an entity qualifier, an action qualifier, or an action parameter.

3. The method of claim 1, the search query received through an app search interface associated with an app store.

4. The method of claim 1, the determining a search intent comprising at least one of:
utilizing the search query to assign classifier scores to one or more potential entity categories, a classifier score indicating an amount of correlation between the search query and a potential entity category;
performing a grammar evaluation of the search query to identify the search intent;
invoking a web search engine to evaluate the search query to identify the search intent;
invoking an entity extractor to identify one or more entities as the search intent.

5. The method of claim 1, the determining a search intent comprising:
consulting a search user profile for the search user.

6. The method of claim 1, the user context corresponding to at least one of a user location, a user segment, or a user session.

7. The method of claim 1, the determining a search intent comprising:
determining a global context for inclusion within the search intent, the global context corresponding to at least one of a current time, a current event, or a local event in relation to a location of the search user.

8. The method of claim 1, comprising:
deriving the set of tasks parameters to comprise at least one of an entity, the action, an entity qualifier, an action qualifier, or an action parameter.

9. The method of claim 8, the entity qualifier comprising a locational qualifier for the entity.

10. The method of claim 8, the action parameter comprising at least of a temporal parameter, a locational parameter, a quantity parameter, a payment parameter, or a parameter used by the app to perform the action.

11. The method of claim 1, comprising:
responsive to a task completion setting indicating automatic performance of the action, invoking the app to perform the action without soliciting user input from the search user.

12. The method of claim 1, the providing the app comprising:
instructing the app to display a user interface exposing functionality invokable by the search user to perform the action.

13. The method of claim 1, the providing the app comprising:
identifying the app within an app store, the app not local to a device of the search user.

14. A method for annotating an app for facilitating performance of a user search task, comprising:
identifying an app exposed through an app store;
evaluating app metadata associated with the app to determine an app subcategory, the app metadata comprising at least one of an app description for the app specified by the app store, a user review for the app, an app developer description for the app, or an app catalogue category for the app specified by the app store;
annotating the app with the app subcategory as an app subcategory annotation; and
responsive to determining that a search intent of a search query, submitted by a search user, corresponds to the app subcategory annotation, providing the app to the search user.

15. The method of claim 14, the evaluating comprising evaluating the app metadata to determine an action capable of being performed by the app, the method comprising:
annotating the app with the action as an action context annotation; and
responsive to determining that the search query corresponds to the action context annotation, providing the app to the search user.

16. The method of claim 14, the evaluating comprising evaluating the app metadata to determine a location context associated with the app, the method comprising:
annotating the app with the location context as a location context annotation; and
responsive to determining that search query corresponds to the location context annotation, providing the app to the search user.

17. The method of claim 14, the evaluating comprising evaluating the app metadata to determine a user segment context associated with the app, the method comprising:
annotating the app with the user segment context as a user segment context annotation; and
responsive to determining that search query corresponds to the user segment context annotation, providing the app to the search user.

18. The method of claim 14, the evaluating comprising evaluating the app metadata to determine an event context associated with the app, the method comprising:
annotating the app with the event context as an event context annotation; and
responsive to determining that search query corresponds to the event context annotation, providing the app to the search user.

19. A system facilitating performance of a user search task, comprising:
an app annotation component configured to:
evaluate app metadata associated with an app, exposed through an app store, to determine app annotation data for the app, the app annotation data specifying at least one of an app subcategory, an action, a location context, a user segment context, or an event context; and
annotate the app with an annotation based upon the app annotation data; and
a query processing component configured to:
determine a search intent associated with a search query submitted by a search user;
responsive to determining that the search intent corresponds to the annotation, providing the app to the search user in a contextually relevant state based upon a set of task parameters derived from the search intent.

20. The system of claim 19, the query processing component configured to:
determine the search intent based upon at least one of a user location of the search user, a user segment indicative of a demographic for the search user, a current event, or a local event in relation to a location of the search user.
